(19) United States
(12) Patent Application Publication
(10) Pub. No.: US 2025/0300301 A1
(43) Pub. Date: Sep. 25, 2025

(54) BATTERY CELL HOLDER, BATTERY MODULE, AND BATTERY PACK

(71) Applicant: Isuzu Motors Limited, Yokohama-shi (JP)

(72) Inventor: Hiroyuki SUGAWARA, Fujisawa-shi (JP)

(73) Assignee: Isuzu Motors Limited, Yokohama-shi (JP)

(21) Appl. No.: 19/058,070

(22) Filed: Feb. 20, 2025

(30) Foreign Application Priority Data
Mar. 19, 2024 (JP) 2024-043704

(51) Int. Cl. H01M 50/267; H01M 50/213

(52) U.S. Cl. CPC H01M 50/267; H01M 50/213

(57) ABSTRACT

Provided is a battery cell holder including a housing portion that houses a columnar battery cell, in which the housing portion includes: a first housing portion that is a columnar space having a first diameter; and a second housing portion that is a columnar space having a second diameter smaller than the first diameter, and in which, when viewed from above, the housing portion has a shape in which an outer circumference of the first housing portion and an outer circumference of the second housing portion are partly combined with each other.

### CROSS REFERENCE TO RELATED APPLICATIONS

This application claims the benefit of priority of Japanese Patent Application No. 2024-043704, filed on Mar. 19, 2024, the disclosure of which including the specification, drawings and abstract is incorporated herein by reference in its entirety.

### TECHNICAL FIELD

The present disclosure relates to a battery cell holder, a battery module, and a battery pack.

### BACKGROUND ART

Conventionally, battery cell holders capable of holding a plurality of battery cells are used in battery modules mounted on vehicles or the like.

For example, the Patent Literature (hereinafter referred to as “PTL”) discloses a battery cell holder including a plurality of cylindrical housing portions corresponding to the size of cylindrical battery cells.

### CITATION LIST

### Patent Literature

PTL
Japanese Patent Application Laid-Open No. 2022-61466

### SUMMARY OF INVENTION

### Technical Problem

In general, battery modules come in various sizes depending on their capacity and application. However, in the battery cell holder of the PTL, the housing portions are all the same in size, and thus, only one size of battery cells can be housed.

Therefore, when multiple types of battery cells with different diameters are used, it is necessary to newly design and manufacture cell holders including housing portions respectively corresponding to the diameters, which incurs additional costs.

### Solution to Problem

A battery cell holder according to an aspect of the present disclosure includes a housing portion that houses a columnar battery cell, in which the housing portion includes: a first housing portion that is a columnar space having a first diameter; and a second housing portion that is a columnar space having a second diameter smaller than the first diameter, and in which, when viewed from above, the housing portion has a shape in which an outer circumference of the first housing portion and an outer circumference of the second housing portion are partly combined with each other.

A battery module according to an aspect of the present disclosure includes the battery cell holder according to an aspect of the present disclosure.

A battery pack according to an aspect of the present disclosure includes the battery module according to an aspect of the present disclosure.

### Advantageous Effects of Invention

According to the present disclosure, it is possible to house multiple types of battery cells of different sizes without incurring costs.

### BRIEF DESCRIPTION OF DRAWINGS

FIG. 1 is a perspective view of a cell holder according to an embodiment of the present disclosure;

FIG. 2 is a top view of the cell holder according to the embodiment of the present disclosure;

FIG. 3 is a top view and a cross-sectional view of a housing portion;

FIG. 4 is a top view and a cross-sectional view of the housing portion according to the embodiment of the present disclosure when a small cell is housed;

FIG. 5 is a top view and a cross-sectional view of the housing portion according to the embodiment of the present disclosure when a large cell is housed;

FIG. 6 is a top view of a housing portion according to Variation 1 of the present disclosure;

FIG. 7 is a top view and a cross-sectional view of a housing portion according to Variation 2 of the present disclosure;

FIG. 8 is a top view and a cross-sectional view of the housing portion according to Variation 2 of the present disclosure when a small cell is housed;

FIG. 9 is a top view and a cross-sectional view of the housing portion according to Variation 2 of the present disclosure when a large cell is housed;

FIG. 10 is a top view and a cross-sectional view of a housing portion according to Variation 3 of the present disclosure;

FIG. 11 is a top view and a cross-sectional view of the housing portion according to Variation 3 of the present disclosure when a small cell is housed;

FIG. 12 is a top view and a cross-sectional view of the housing portion according to Variation 3 of the present disclosure when a large cell is housed; and

FIG. 13 is a top view of a cell holder according to Variation 3 of the present disclosure.

### DESCRIPTION OF EMBODIMENTS

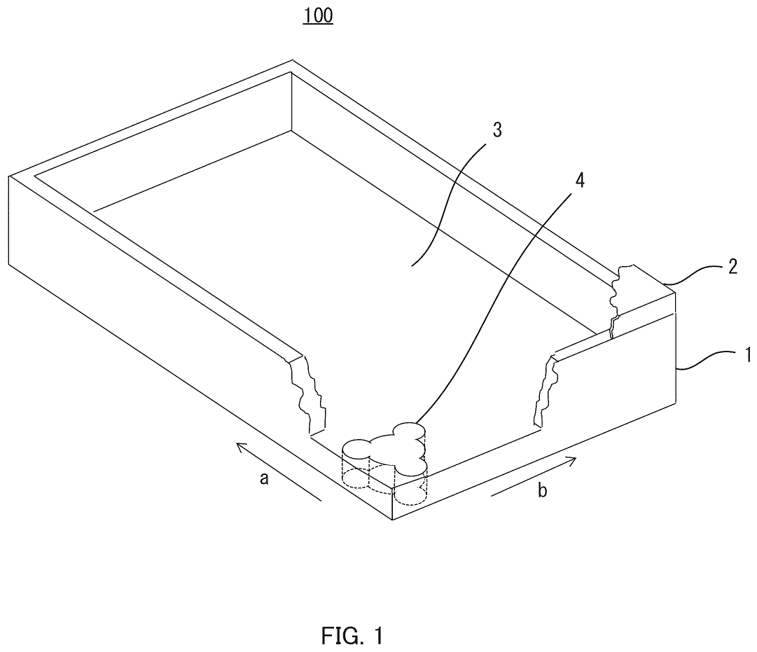

Hereinafter, battery cell holder 100 according to an embodiment of the present disclosure will be described with reference to FIGS. 1 to 5.

Battery cell holder 100 of the present embodiment is a member for holding a plurality of battery cells in a battery module.

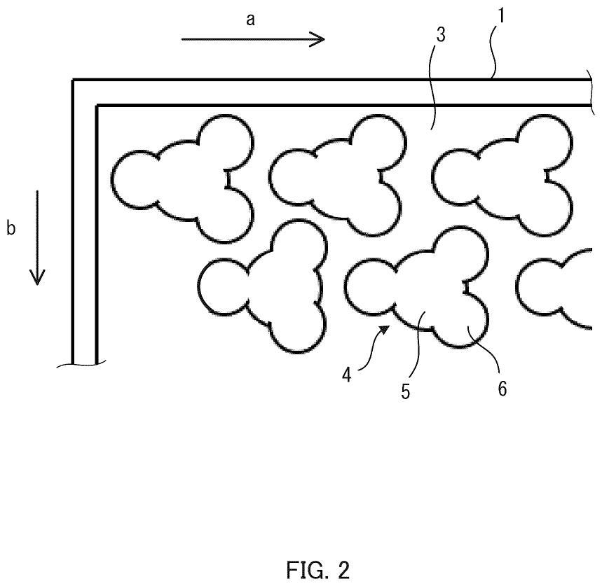

First, a configuration of battery cell holder 100 will be described with reference to FIGS. 1 and 2. FIG. 1 is a perspective view of battery cell holder 100. FIG. 2 is a top view of battery cell holder 100.

As illustrated in FIG. 1, battery cell holder 100 includes: case 1 that has a rectangular shape with an open top; and lid 2 that has a flat plate-shape and covers the top surface of case 1. Note that, in FIG. 1, a part of a side surface of case 1 and a large part of lid 2 are omitted from the illustration.

Housing portion 4 that houses a cylindrical (an example of a columnar shape) battery cell is provided on bottom surface 3 of case 1. In FIG. 1, for convenience, only one housing portion 4 is illustrated, but in reality, as illustrated in FIG. 2, a plurality of housing portions 4 are provided along a longitudinal direction (direction of arrow a) of case 1 and a transverse direction (direction of arrow b) of the case. Note that, in FIG. 2, only a part of case 1 (bottom surface 3) is illustrated.

As illustrated in FIG. 2, plurality of housing portions 4 are provided to be separated from each other. Further, as illustrated in FIG. 2, plurality of housing portions 4 are arranged in a staggered manner with respect to each other. Further, first housing portions 5 and second housing portions 6 (details will be described later) included in the plurality of housing portions 4 are also respectively arranged in a staggered manner.

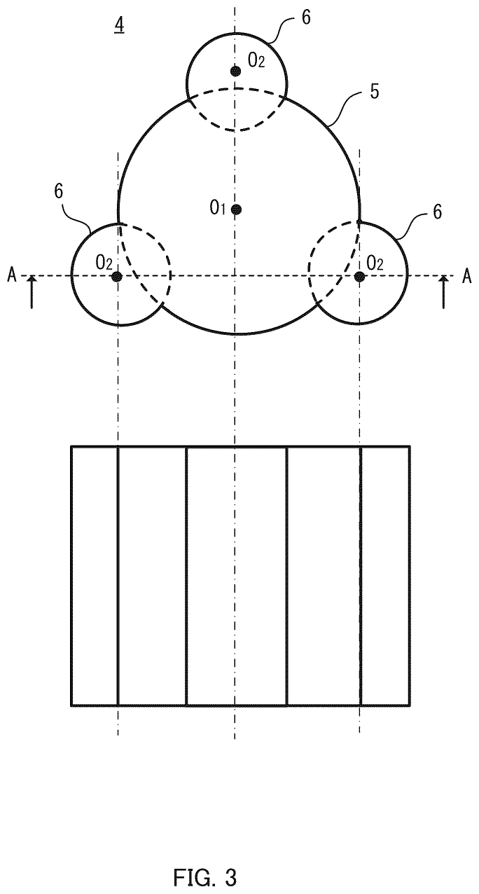

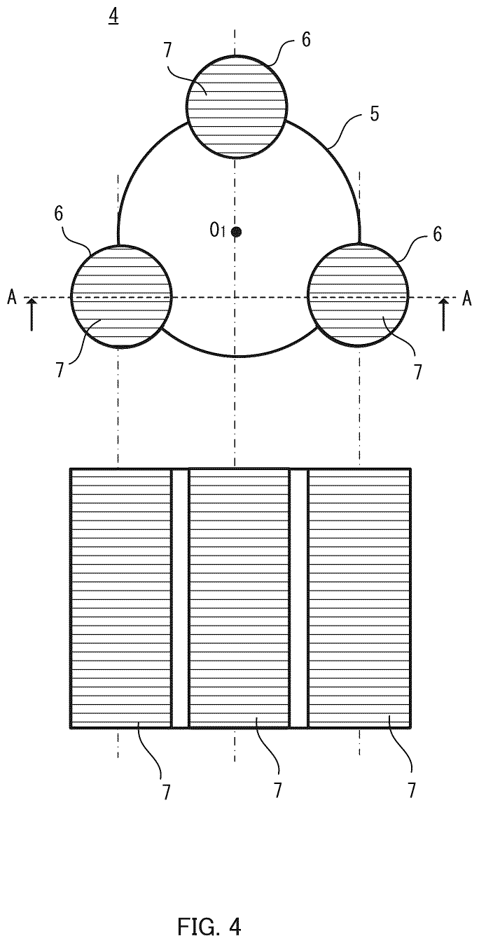

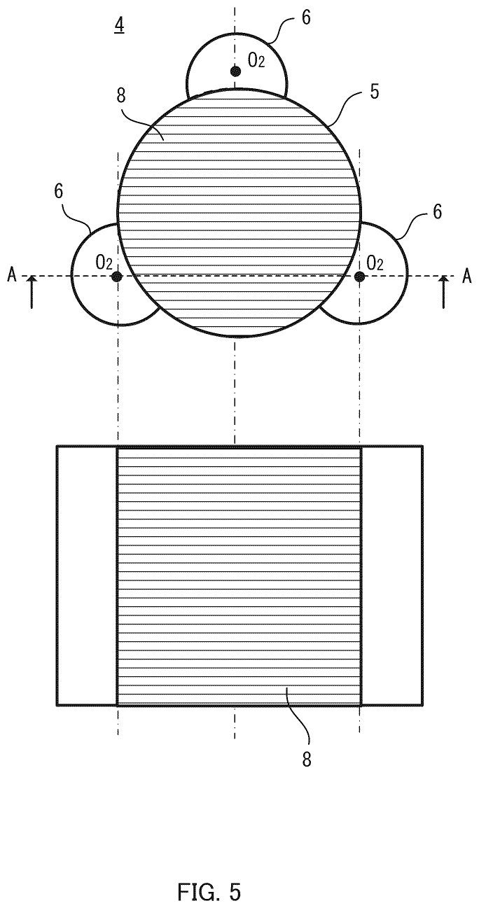

Next, a configuration of housing portion 4 will be described with reference to FIGS. 3 to 5. FIG. 3 is a top view and a cross-sectional view taken along an A-A line (hereinafter referred to as A-A cross-sectional view) of housing portion 4 when no battery cell is housed. FIG. 4 is a top view and an A-A cross-sectional view of housing portion 4 when a small-sized battery cell is housed. FIG. 5 is atop view and an A-A cross-sectional view of housing portion 4 when a large-size battery cell is housed. In FIGS. 3 to 5, the upper drawing is a top view, and the lower drawing is an A-A cross-sectional view. Note that, in FIGS. 3 to 5, dotted lines and dash-dotted lines in the drawings are virtual lines.

As illustrated in FIG. 3, housing portion 4 includes one first housing portion 5 and three second housing portions 6.

First housing portion 5 is a cylindrical space with center O₁ and a first diameter. Each second housing portion 6 is a cylindrical space with center O₂ and a second diameter smaller than the first diameter.

Further, housing portion 4 has a shape in which an outer circumference of first housing portion 5 are partly combined with outer circumferences of second housing portions 6, when viewed from above (in other words, when viewed from an axial direction of housing portion 4).

With the above-described shape, housing portion 4 can house two types of battery cells with different sizes. That is, as illustrated in FIG. 4, small-sized battery cells 7 (hereinafter, referred to as small cells 7) are housed in second housing portions 6. Further, as illustrated in FIG. 5, large-sized battery cell 8 (hereinafter, referred to as large cell 8) is housed in first housing portion 5.

Note that, as illustrated in FIG. 3, when housing portion 4 is viewed from above, centers O₂ of second housing portions 6 are preferably located outside the outer circumference of first housing portion 5. Alternatively, centers O2 of second housing portions 6 may be located on or above the outer circumference of first housing portion 5. Thus, each second housing portion 6 can secure an arc with a central angle of 180 degrees or more when viewed from above, thereby enhancing the force for holding small cell 7.

Further, in the present embodiment, a case where three second housing portions 6 are provided has been described as an example, but the number of second housing portions 6 combined with one first housing portion 5 may be at least two or more.

As described above, battery cell holder 100 of the present embodiment includes housing portion 4 that houses a columnar battery cell, in which housing portion 4 is characterized to include: first housing portion 5, which is a columnar space having a first diameter; and second housing portions 6, each of which is a columnar space having a second diameter smaller than the first diameter, and, when viewed from above, to have a shape in which an outer circumference of first housing portion 5 are partly combined with outer circumferences of second housing portions 6.

With this feature, it is made possible to house a plurality of types of battery cells in one battery cell holder. Further, combination of first housing portion 5 and second housing portions 6 enables the efficient utilization of a limited area of bottom surface 3, thereby housing more battery cells. Accordingly, it is possible to provide a battery cell holder with excellent convenience and cost effectiveness.

Although not illustrated, a battery module of the present embodiment is configured with battery cell holder 100 described above and a plurality of battery cells (small cell 7 or large cell 8) housed in battery cell holder 100. The plurality of housed battery cells are connected in series or in parallel, and are used with the capacity, the voltage, and the like adjusted to predetermined values.

Further, although not illustrated, a battery pack of the present embodiment is configured with the battery module described above. In addition to the battery module described above, the battery pack may include, for example, a battery management system for monitoring voltage and temperature, a charge/discharge circuit, a cooling mechanism, and the like.

The present disclosure is not limited to the description of the above-described embodiment, and various modifications can be made within the scope not departing from the spirit of the present disclosure. In the following, variations will be described.

### [Variation 1]

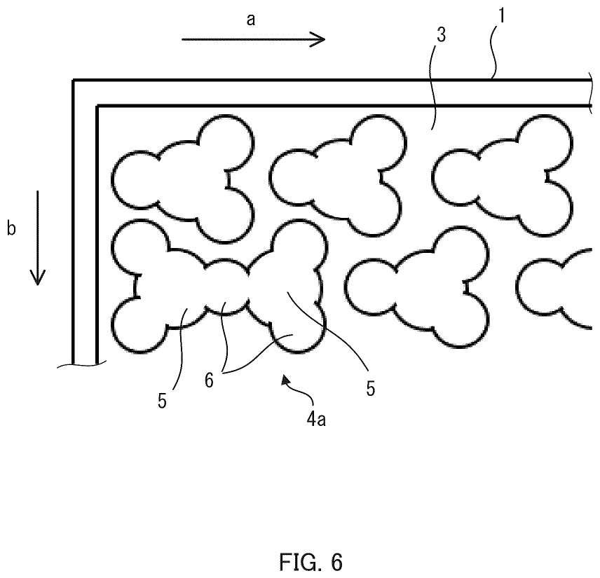

In the embodiment, a case where a plurality of housing portions 4 are provided to be separated from each other (see FIG. 2) has been described as an example, but the present disclosure is not limited to this case. For example, two housing portions 4 may be combined and provided as housing portion 4a illustrated in FIG. 6.

### [Variation 2]

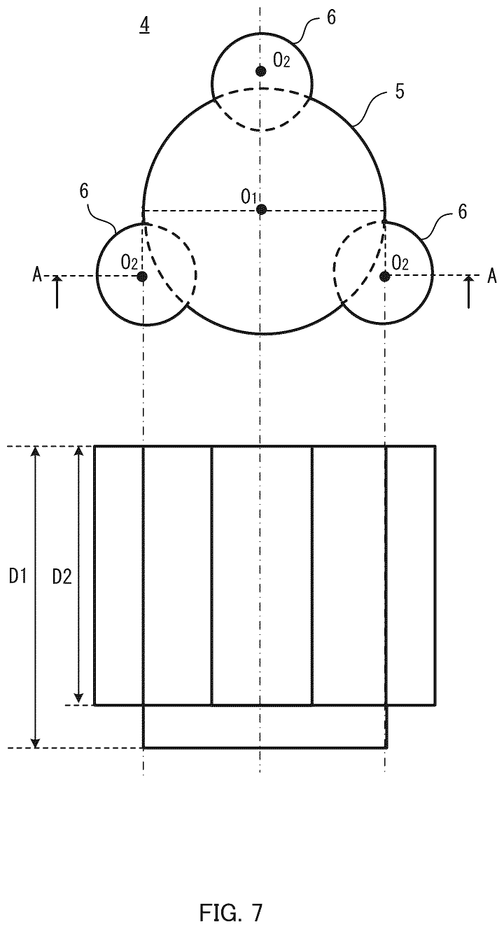

In the embodiment, a case where the depth (length in the axial direction) of first housing portion 5 and the depth (length in the axial direction) of second housing portion 6 are the same has been described as an example, but the present disclosure is not limited to this case. For example, the depth of first housing portion 5 may be deeper than the depth of second housing portion 6. This case will be described below with reference to FIGS. 7 to 9. FIGS. 7 to 9 are each a top view and an A-A cross-sectional view of housing portion 4, similar to FIGS. 3 to 5.

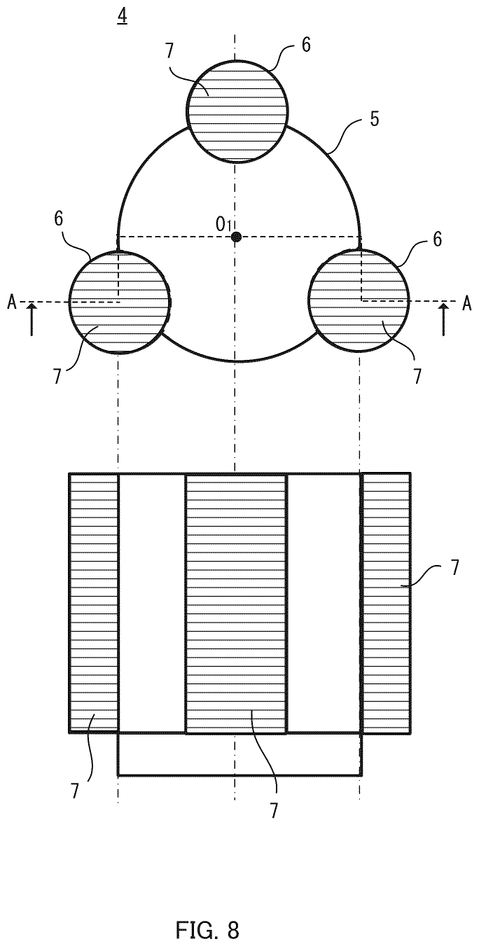

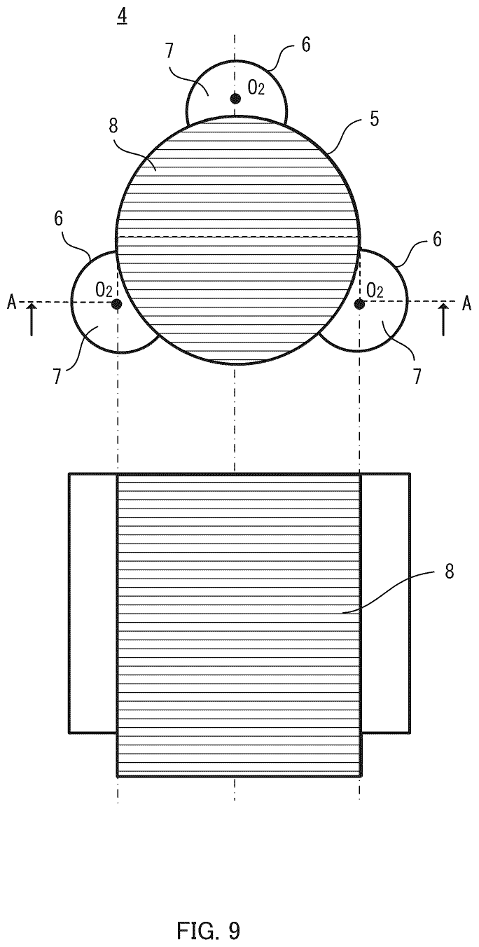

As illustrated in FIG. 7, depth D1 of first housing portion 5 is deeper (longer) than depth D2 of each second housing portion 6. Then, as illustrated in FIG. 8, small cells 7 are housed in second housing portions 6, and as illustrated in FIG. 9, large cell 8 is housed in first housing portion 5.

As is apparent from FIGS. 8 and 9, in the present variation, the length of large cell 8 in the axial direction is longer than the length of each small cell 7 in the axial direction (in other words, the height of large cell 8 is higher than the height of each small cell 7). On the other hand, as illustrated in FIGS. 8 and 9, both small cells 7 and large cell 8 are housed without protruding from an upper surface of housing portion 4. That is, in the present variation, even in a case where the length of each small cell 7 and the length of large cell 8 in the axial direction are different, small cells 7 and large cell 8 can be housed without protruding from the upper surface of housing portion 4.

Further, in the present variation, the holding force is improved in a lower portion of first housing portion 5 (portion that is deeper than second housing portion 6).

### [Variation 3]

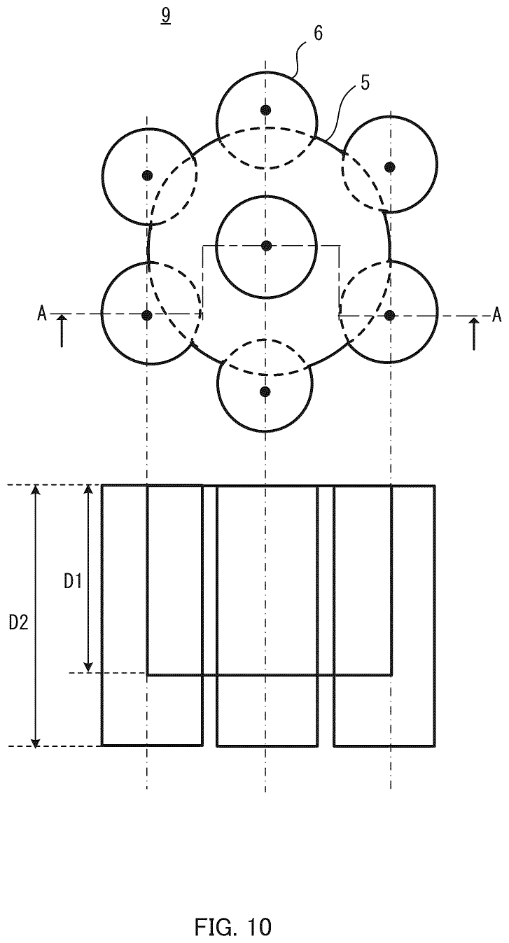

In the embodiment, a case where housing portion 4 has a shape in which three second housing portions 6 are combined with one first housing portion 5 has been described as an example, but the present disclosure is not limited to this case. Hereinafter, housing portion 9, which has a shape in which seven second housing portions 6 are combined with one first housing portion 5, will be described with reference to FIGS. 10 to 12. FIGS. 10 to 12 are each a top view and an A-A cross-sectional view of housing portion 9, similar to FIGS. 3 to 5.

As illustrated in the top view of FIG. 10, housing portion 9 has a shape in which six second housing portions 6 are combined with an outer circumference portion of first housing portion 5, and one second housing portion 6 is combined with a central portion of first housing portion 5.

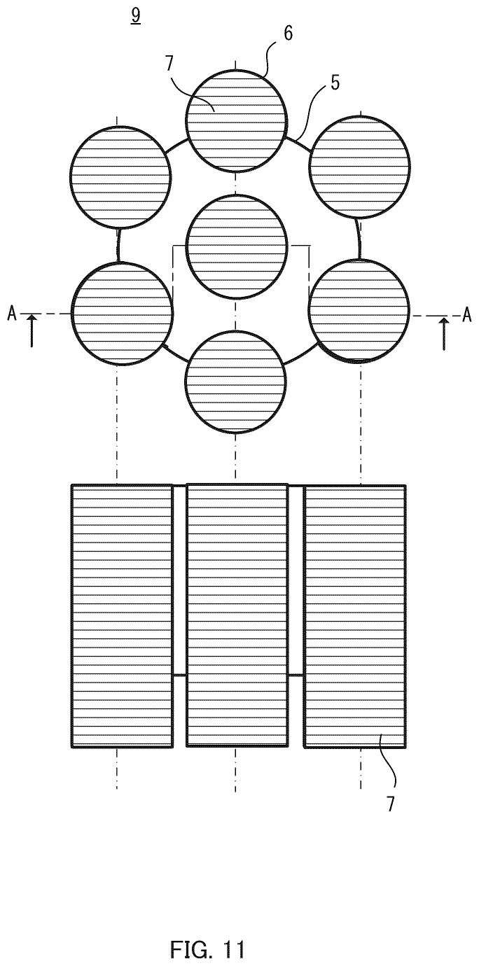

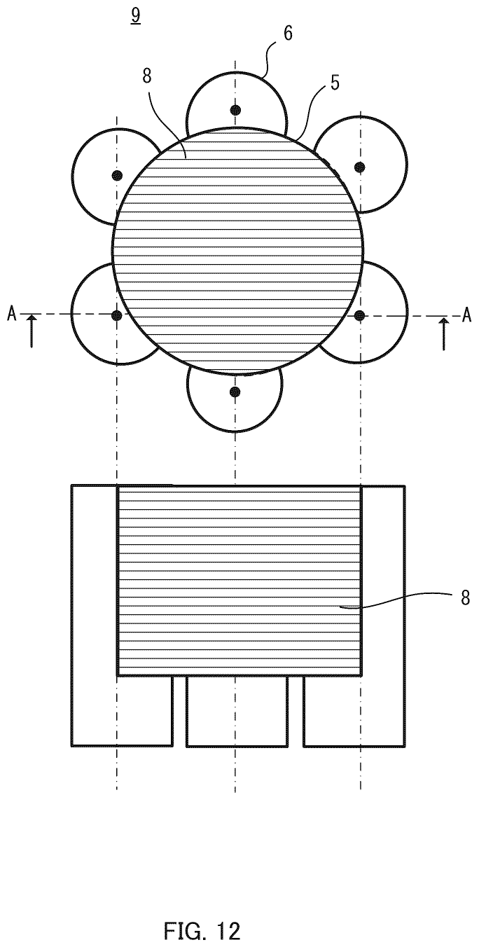

Further, as illustrated in the A-A cross-sectional view of FIG. 10, depth D2 of each second housing portion 6 is deeper (longer) than depth D1 of first housing portion 5 in housing portion 9. Then, as illustrated in FIG. 11, small cells 7 are housed in second housing portions 6, and as illustrated in FIG. 12, large cell 8 is housed in first housing portion 5.

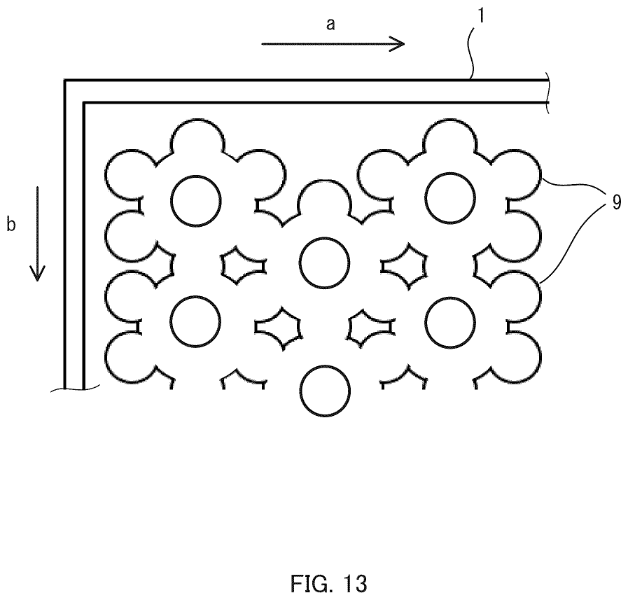

A plurality of housing portions 9 described above may be provided to be separated from each other on bottom surface 3 of case 1, or may be provided to be combined with each other as illustrated in FIG. 13. Further, as illustrated in FIG. 13, the plurality of housing portions 9 (first housing portions 5 and second housing portions 6 included therein) may be arranged in a staggered arrangement with respect to each other.

### [Variation 4]

In the present embodiment, a case where the battery cell is cylindrical has been described as an example, but the present disclosure is not limited to this case, and the battery cell may be prismatic. In this case, first housing portion 5 and second housing portion 6 also have a prismatic shape.

### INDUSTRIAL APPLICABILITY

The battery cell holder of the present disclosure is useful in a technology for housing a plurality of battery cells.

### REFERENCE SIGNS LIST

1 Case
2 Lid
3 Bottom surface
4, 9 Housing portion
5 First housing portion
6 Second housing portion
7 Small-size battery cell (small cell)
8 Large-size battery cell (large cell)
100 Battery cell holder

1. A battery cell holder, comprising:
a housing portion that houses a columnar battery cell,
wherein the housing portion includes:
a first housing portion that is a columnar space having a first diameter; and
a second housing portion that is a columnar space having a second diameter smaller than the first diameter, and
wherein, when viewed from above, the housing portion has a shape in which an outer circumference of the first housing portion and an outer circumference of the second housing portion are partly combined with each other.

2. The battery cell holder according to claim 1, wherein, when viewed from above, a center of the second housing portion is located on or above the outer circumference of the first housing portion or outside the outer circumference.

3. The battery cell holder according to claim 1, wherein, when viewed from above, at least two of a plurality of the second housing portions are combined with one first housing portion.

4. The battery cell holder according to claim 1, wherein:
a plurality of the housing portions are provided, and
a plurality of the first housing portions and a plurality of the second housing portions included in the plurality of housing portions are respectively arranged in a staggered manner, when viewed from above.

5. The battery cell holder according to claim 1, wherein a depth of the first housing portion is deeper than a depth of the second housing portion.

6. A battery module, comprising the battery cell holder according to claim 1.

7. A battery pack, comprising the battery module according to claim 6.
